(19) United States
(12) Patent Application Publication
(10) Pub. No.: US 2008/0141905 A1
(43) Pub. Date: Jun. 19, 2008

(54) Method for the Surface Treatment of Solid Particles, Particularly Titanium Dioxide Pigment Particles

(76) Inventors: Volker Juergens, Kirchhundem (DE); Juergen Orth-Gerber, Undenheim (DE); Lydia Drews-Nicolai, Koeln (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/941,156

(22) Filed: Nov. 16, 2007

Related U.S. Application Data
(60) Provisional application No. 60/870,526, filed on Dec. 18, 2006.

(30) Foreign Application Priority Data
Dec. 15, 2006 (DE) DE 102006059849.0

(51) Int. Cl. B05D 7/24; B05D 7/14; C04B 14/34

(52) U.S. Cl. 106/446; 427/215; 106/436

(57) ABSTRACT

A method for manufacturing inorganic solid particles, particularly titanium dioxide pigment particles, with a smooth and homogeneous surface coating in an aqueous suspension.

### RELATED APPLICATION

This application claims the benefit of U.S. Provisional Patent Application Ser. No. 60/870,526 filed Dec. 18, 2006 and the benefit of DE 10 2006 059 849.0 filed Dec. 15, 2006.

### FIELD OF THE INVENTION

The invention relates to a method for manufacturing inorganic solid particles, particularly titanium dioxide pigment particles, with a smooth and homogeneous surface coating in an aqueous suspension.

### BACKGROUND OF THE INVENTION

Fine inorganic solid particles are often surface-coated in order to modify certain properties, such as surface charge, dispersing properties, acid resistance or light stability. For example, U.S. Pat. No. 2,885,366 describes the application of a silicon dioxide coating to substrate particles, such as nickel or iron powder, glass fibres or titanium dioxide. Color and white pigments are regularly coated with various oxides and hydroxides (e.g. U.S. Pat. No. 4,530,725; US Re. 27,818).

Surface treatment (surface coating), particularly of TiO₂ pigments, customarily takes place in the aqueous phase, where metal oxides, hydroxides, phosphates or similar compounds are deposited on the particle surface. The method is usually operated as a batch process. Starting with an aqueous pigment particle suspension, corresponding metal salts are added in dissolved form as so-called precursor compounds, and the pH value of the suspension is adjusted with alkaline or acidic substances in such a way that the precursor compounds are precipitated as oxides, hydroxides, etc.

Typically, pigment agglomeration easily occurs in the suspension, meaning that the deposited coating substances do not enclose the individual particle, but often an agglomerate. The agglomerates are again disintegrated during final dry-milling, the result being that, in the final product, not all particles are provided with a closed skin, but instead also display uncoated areas on the surface. Moreover, part of the coating substances is not fixed on the particle surface, but forms floccules alongside the particles. These floccules can no longer be removed from the suspension and negatively impact the optical properties of the pigments, such as the tinting strength (TS).

GB 1 340 045 describes a method for coating the surface of a titanium dioxide pigment, where a suspension of the pigment is subjected to intensive agitation in a mixing vessel for up to two hours, during which time the coating substances are added and applied. The method is performed in batch mode. A corresponding pH value is set in the suspension to precipitate the coating substances. As a result of the treatment, a pigment filter cake with a higher solids content is formed and the gloss retention of paint media incorporating the pigment is improved.

### SUMMARY OF THE INVENTION

The present method creates a smooth, homogeneous and continuous surface coating produced on solid particles that is improved compared to the prior art.

The present method provides for the surface coating of inorganic solid particles in an aqueous suspension, wherein the particles are surface-coated with at least one inorganic substance while the suspension is being passed through an agitator mill.

The subject matter of the invention is thus a method for covering solid particles with a smooth, homogeneous and closed coating of inorganic compounds.

### BRIEF DESCRIPTION OF THE DRAWING

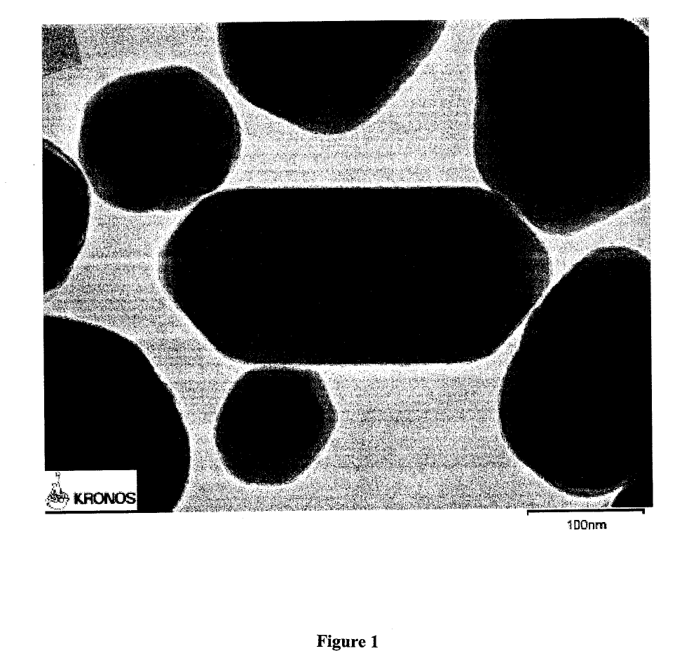

For a more complete understanding of the present invention and for further advantages thereof, reference is now made to the following Description of the Preferred Embodiments taken in conjunction with the accompanying Drawing in which FIG. 1 is a transmission electron microscopy photograph of particles coated in accordance with the present invention as described with respect to Example 7.

### DESCRIPTION OF THE PREFERRED EMBODIMENTS

In the context of the invention the terms “surface treatment” and “surface coating” are used as equivalents.

In contrast to a batch method, the method according to the present invention is characterised by a continuous operating mode. The solution containing the coating substances is added to the suspension before or while the latter is passed through the agitator mill. Surprisingly, very smooth, homogeneous and closed coating of the individual particles is achieved compared to the known surface treatment methods, such that less uncoated particle surface and less separately flocculated coating substance are present following final micronisation. TiO₂ pigments treated accordingly display a significantly improved TS.

In the context of the present invention, the term agitator mills is understood as meaning dispersing machines in which a bed of grinding media is set in motion by an agitator shaft. The mill base is added in suspended state, preferably in an aqueous suspension. During milling or dispersion, the mill base particles experience both impact stress, e.g. resulting from collision with the grinding media, the agitator shaft or the vessel wall, and also shear stress in the fluid. The mechanism of action can be shifted towards the impact effect or the shear effect by controlling the mechanical agitator power in conjunction with the temperature-dependent viscosity properties of the fluid (see: J. Winkler “Nanopigmente dispergieren” [Dispersing Nanopigments], Farbe und Lack 112 No. 2 (2006), p. 35 to 39).

Agitator mills are known in the form of bead mills or sand mills, for example; however, the present method is not limited to the use of such bead mills or sand mills.

Suitable for the method according to the present invention are fine inorganic solids with a particle size in the range from roughly 0.001 to 1 μm that are processed in aqueous suspensions, e.g. pigments (titanium dioxide, color pigments, effect pigments, etc.), fillers, titanates, iron, nickel or other magnetic particles.

The particles are present in an aqueous suspension. They can previously have undergone milling, e.g. in a sand mill.

The coating substances are inorganic substances and include, for example, and not by way of limitation, the oxides, hydroxides, phosphates and sulphates of the familiar elements Si, Ti, Al, Zr, Sn and further elements. In an embodiment of the present invention the one or more coating substances are added to the suspension in the form of water-soluble salts (referred to as metal salts below). The person skilled in the art is familiar with the corresponding metal salts.

Where appropriate, the suspension also contains dispersants, e.g. sodium silicate, hexametaphosphate and others.

In one embodiment of the present invention, the metal salt is added to the suspension before entry into the agitator mill, e.g. during repulping or in the feed line upstream of the mill. Alternatively, the solution containing the coating substances can be fed into the agitator mill. No significant quantities of separate flocculations of the coating substance are found in the treated suspension at the outlet of the agitator mill. The shear forces exerted possibly have the effect of the coating substance initially being adsorbed on the particle surface and subsequently precipitated better on the surface prepared in this way.

According to the present invention the particles are coated with one or several inorganic coating substances.

The surface treatment according to the present invention can be followed by classical aqueous surface treatment. The particles are subsequently separated by filtration, washed where appropriate, dried and micronised.

In an embodiment of the present method, titanium dioxide particles are provided with a dense SiO₂ skin. A suspension of untreated TiO₂ particles (TiO₂ base material) in anatase or rutile form is provided for this purpose. The coating substance is preferably added in the form of an Na or K waterglass solution. The method can be performed with suspensions having a pH value of 4 and higher. It is not necessary for the pH value of the suspension to be made alkaline at the start or adjusted in the further course. The process is regulated by controlling the mechanical agitator power in conjunction with the viscosity properties of the fluid (see: J. Winkler “Nanopigmente dispergieren” [Dispersing Nanopigments], Farbe und Lack 112 No. 2 (2006), p. 35 to 39).

In a further embodiment of the present invention, several separate layers can be precipitated onto the surface by the suspension being passed through several agitator mills in series, or circulated through a single agitator mill. A metal salt solution is in each case added to the suspension before it enters the mill, or via a feed line to the mill. The solutions can be different and each contain several compounds.

For example, the particles are provided with a SiO₂ layer in a first pass through the agitator mill, and with an Al₂O₃ layer in a second pass.

It is moreover possible to apply only one part of the desired coating substance to the particle surface during agitator milling, the other part subsequently being applied during a classical surface coating process.

For example, the particles are provided with a layer consisting of roughly 20 to 50% of the envisaged total quantity of SiO₂ in the agitator mill. The remaining 80 to 50% of the SiO₂ are subsequently applied in the framework of a classical surface coating process.

In a further embodiment, titanium dioxide particles are first provided with an SiO₂ layer in the agitator mill, and a final Al₂O₃ layer is subsequently applied in the framework of a classical surface coating process.

Following filtration and washing, the particles are dried and, in a further embodiment, subsequently heat-treated at temperatures of 250 to 600° C., preferably at 350 to 450° C. The dried or heat-treated TiO₂ particles are subsequently micronised. One or more organic substances are added during micronisation, where appropriate. Organic substances can also be added after micronisation, with the help of suitable mixing units.

The method according to the present invention is characterised by the fact that very homogeneous, smooth coating of the particles is achieved. In particular, TiO₂ pigments manufactured in this way display improved tinting strength and high weather resistance. The pigments are eminently suitable for use in plastics, particularly masterbatches, as well as in coatings, particularly paints, and in laminates.

Furthermore, the method according to the present invention constitutes a simplification in comparison with classical surface treatment. An effective coating can be applied to the solid particles in a shorter time. Compared to the classical method, the method according to the present invention is additionally characterised by higher efficiency, since less coating material flocculates separately.

### EXAMPLES

The present invention is explained in more detail below on the basis of several examples, without these being intended as a limitation. The quantities given refer to the TiO₂ base material in each case.

The examples used two TiO₂ base material qualities that differ in terms of tone (spectral characteristic SC). In this context, the term TiO₂ base material refers to the TiO₂ particle that has not yet been surface-treated. The SC value of base material A is roughly 1.5 higher than the SC value of base material B. Common TiO₂ base material qualities display SC values between roughly 3 and 7.

### Reference Example 1

A sand-milled TiO₂ suspension, containing base material quality A manufactured according to the chloride process, is diluted with water to a concentration of 350 g/l. The suspension is then heated to 70° C. and set to a pH value of 10 with NaOH. While stirring, 2.2% by weight SiO₂ are added to the suspension in the form of sodium waterglass. The pH value is subsequently set to 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Reference Example 2

A sand-milled TiO₂ suspension, containing base material quality B manufactured according to the chloride process, is set to a pH value of 11 with NaOH and passed through a vertical sand mill (Model PM5, Draiswerke GmbH) at 5 kg/h. The suspension is subsequently diluted with water to a concentration of 350 g/l, heated to 70° C. and set to a pH value of 10 with NaOH. While stirring, 2.2% by weight SiO₂ are added to the suspension in the form of sodium waterglass. The pH value is subsequently set to 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Reference Example 3

A sand-milled TiO₂ suspension, containing base material quality B manufactured according to the chloride process, is diluted with water to a concentration of 350 g/l. The suspension is then heated to 70° C. and set to a pH value of 10 with NaOH. While stirring, 2.2% by weight SiO₂ are added to the suspension in the form of sodium waterglass. The pH value is subsequently set to 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Example 1

A sand-milled TiO₂ suspension with a concentration of 500 g/l, containing base material quality A manufactured according to the chloride process, is set to a pH value of 11.5 with NaOH. 2.2% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, set to a pH value of 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is steam-milled in a spiral jet mill during addition of an ethoxy and propyl-bearing siloxane.

### Example 2

A sand-milled TiO₂ suspension with a concentration of 500 g/l, containing base material quality A manufactured according to the chloride process, is set to a pH value of 11.5 with NaOH. 2.2% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, set to a pH value of 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Example 3

A sand-milled TiO₂ suspension with a concentration of 500 g/l, containing base material quality A manufactured according to the chloride process, is set to a pH value of 8 with HCl. 2.2% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, set to a pH value of 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Example 4

A TiO₂ suspension with a concentration of 500 g/l, containing base material quality A manufactured according to the chloride process, is set to a pH value of 4 with NaOH. 2.2% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, set to a pH value of 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Example 5

A TiO₂ suspension with a concentration of 500 g/l, containing base material quality A manufactured according to the chloride process, is set to a pH value of 11.5 with NaOH. 2.2% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, set to a pH value of 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Example 6

A TiO₂ suspension with a concentration of 500 g/l, containing base material quality A manufactured according to the chloride process, is set to a pH value of 11.5 with NaOH. 0.5% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, 1.7% by weight SiO₂ are added in the form of sodium waterglass. The suspension is subsequently set to a pH value of 4 with HCl within a period of 70 minutes. Moreover, 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Example 7

A sand-milled TiO₂ suspension with a concentration of 500 g/l, containing base material quality A manufactured according to the chloride process, is set to a pH value of 11.5 with NaOH. 2.2% by weight SiO₂ are added to the suspension in the form of sodium waterglass. The suspension is subsequently passed through a horizontal sand mill (Model LME20, Netzsch) at 40 kg/h. The suspension is then diluted to 350 g/l with water, heated to 70° C. and, while stirring, set to a pH value of 4 with HCl within a period of 70 minutes. 0.1% by weight Al₂O₃ are added to the suspension in the form of sodium aluminate.

The suspension is subsequently filtered, washed and dried at 110° C. with the help of a spray drier. The dried material is heat-treated for 1 hour at 420° C. in an electrically heated rotary kiln. The heat-treated material is subsequently steam-milled in a spiral jet mill during addition of an ethoxy and propyl-bearing siloxane.

### Example 8

A sand-milled TiO₂ suspension with a concentration of 500 g/l, containing base material quality B manufactured according to the chloride process, is set to a pH value of 11.5 with NaOH. 2.2% by weight SiO₂ are added to the suspension in the form of sodium waterglass. The suspension is subsequently passed through a vertical sand mill (Model PM5, Draiswerke GmbH) at 5 kg/h. The suspension is then diluted to 350 g/l with water, heated to 70° C. and, while stirring, set to a pH value of 4 with HCl within a period of 70 minutes. 0.4% by weight Al₂O₃ are added to the suspension in the form of sodium aluminate, during which time the pH value is maintained at 4 by appropriate addition of HCl. The pH value is subsequently set to 5.5 with approx. 0.1% by weight Al₂O₃ in the form of sodium aluminate.

The suspension is subsequently filtered, washed and dried in a plate drier for 16 hours at 160° C. The dried material is heat-treated for 2 hours at 420° C. in an electrically heated rotary kiln. The heat-treated material is subsequently steam-milled in a spiral jet mill during addition of an ethoxy and propyl-bearing siloxane.

### Test Methods

The tone or spectral characteristic (SC) of the TiO₂ base material is determined according to DIN 53 165 after incorporation into a black paste at a pigment volume concentration of 17% (so-called MAB method). The grey paste prepared on an automatic muller is applied to a white Morest chart. A HunterLab PD-9000 calorimeter is used to determine the reflectance values of the film in wet state. The SC values derived therefrom are referred to an internal standard.

The tinting strength (TS) of the pigments in the examples and the reference examples is determined after incorporation into a Vinnol black paste at a pigment volume concentration of 1.22% (so-called VIG method).

The titanium dioxide pigment to be tested is pasted with a ready-made Vinnol black paste on an automatic muller.

The grey paste obtained is applied to a chart with a film applicator.

The reflectance values of the film are measured with a HunterLab PD-9000 calorimeter in wet state and referred to an internal standard.

For moisture determination according to Karl Fischer (KF), the water contained in the sample is expelled from the sample in a Karl Fischer oven and transferred to a KF solvent. The redox process of an iodine/SO₂ redox system contained in the KF titrant is activated by the water contained in the sample. The equivalence point of titration is detected by voltammetry. The oven temperature was set to 300° C. The result is expressed as w (H₂O) in percent, referred to the initial sample weight.

The coating of the titanium dioxide particles can be visualised with the help of transmission electron microscopy (TEM).

### Test Results

TABLE 1

| | | Base |
|---|---|---|
| | | material |
| | TS | quality |
| Reference example 1 | 103.1 | A |
| Reference example 2 | 98.8 | B |
| Reference example 3 | 93.8 | B |
| Example 1 | 108.0 | A |
| Example 2 | 106.1 | A |
| Example 3 | 105.3 | A |
| Example 4 | 105.6 | A |
| Example 5 | 104.6 | A |
| Example 6 | 105.5 | A |
| Example 7 | 107.1 | A |
| Example 8 | 103.0 | B |

TABLE 2

| | Moisture (KF) |
|---|---|
| | [% by weight] |
| Example 1 | 0.63 |
| Example 2 | 0.42 |

The method according to the present invention achieves improved tinting strength (TS) (Table 1, Examples 1 to 8) compared to the classical method (Table 1, Reference examples 1 to 3). The TS level depends on the base material quality, as shown by a comparison of Reference example 1 with Reference example 3 and a comparison of Example 2 with Example 8.

Subsequent heat-treatment achieves a substantial decline in the moisture content (Table 2), thus also improving the lacing stability of the corresponding pigment when used in plastic films, for example.

FIG. 1 is a TEM photograph showing that the use of the present method results in particles having a very homogeneous, smooth and closed skin. FIG. 1 shows use of the present method in accordance with the parameters of Example 7.

What is claimed is:

1. A method for manufacturing inorganic solid particles, each particle having a surface, the method comprising:
providing an aqueous suspension of uncoated inorganic solid particles; and
applying a coating of at least one inorganic substance onto the surface of the particles while the suspension passes through an agitator mill.

2. The method of claim 1 and further including:
adding the coating substance to the aqueous suspension prior to the aqueous suspension entering the agitator mill.

3. The method of claim 1, wherein
the coating comprises SiO₂.

4. The method of claim 3 and further applying a coating to the particles comprising Al₂O₃.

5. The method of claim 1 and further including:
heat-treating the solid particles at a temperature of about 250° C. to about 600° C.

6. A titanium dioxide pigment comprising:
titanium dioxide particles, each of the particles having a surface;
a first coating of at least one inorganic substance located on the titanium dioxide particle surface; and
the first coating having been applied to the particle surface using an agitator mill.

7. The titanium dioxide pigment of claim 6 wherein the first coating comprises SiO₂.

8. The titanium dioxide pigment of claim 7 and further including a second coating comprising Al₂O₃ applied to said first coating.

9. A method for manufacturing coated titanium dioxide particles, each particles having a surface, the method comprising:
providing an aqueous suspension, the suspension comprising uncoated titanium dioxide particles; and
applying a coating of at least one inorganic substance onto the surface of the titanium dioxide particles while the suspension passes through an agitator mill.

10. The method of claim 9 wherein the coating comprises SiO₂.

11. The method of claim 10 and further applying a coating to the particles comprising Al₂O₃.

12. The method of claim 9 and further including heat-treating the titanium dioxide particles at a temperature of about 250° C. to about 600° C.

13. A method for manufacturing decorative coating material, comprising:
using titanium dioxide particles coated with at least one inorganic substance, the substance applied using an agitator mill.

14. A method for manufacturing plastic material, comprising:
using titanium dioxide particles coated with at least one inorganic substance, the substance applied using an agitator mill.

15. A method for manufacturing paint material, comprising:
using titanium dioxide particles coated with at least one inorganic substance, the substance applied using an agitator mill.
